(19) United States
(12) Patent Application Publication
(10) Pub. No.: US 2024/0294183 A1
(43) Pub. Date: Sep. 5, 2024

(54) REDUNDANT DRIVE BY WIRE STEERING SYSTEM CONTROL FOR AUTONOMOUS DRIVING VEHICLE

(71) Applicant: Apollo Autonomous Driving USA LLC, Sunnyvael, CA (US)

(72) Inventor: Baoping YUAN, Sunnyvale, CA (US)

(21) Appl. No.: 18/117,294

(22) Filed: Mar. 3, 2023

(51) Int. Cl. B60W 60/00; B60W 10/20; B60W 40/10; B62D 5/04; B62D 6/00

(52) U.S. Cl. CPC B60W 60/001; B60W 10/20; B60W 40/10; B62D 5/0481; B62D 6/00; B60W 2530/00

(57) ABSTRACT

Steering control information and steering motor control information of a primary steering system of the ADV is determined. The steering control information and the steering motor control information of the primary steering system is transferred to a secondary steering system of the ADV. The ADV is controlled, by the primary steering system, to drive autonomously based on the steering control information and the steering motor control information of the primary steering system. In response to detecting a failure of the primary steering system, the ADV is controlled, by the secondary steering system, to drive autonomously based on the steering control information and the steering motor control information of the primary steering system.

### TECHNICAL FIELD

Embodiments of the present disclosure relate generally to operating autonomous driving vehicles. More particularly, embodiments of the disclosure relate to a steering system in an autonomous driving vehicle (ADV).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Safety is critical in an ADV since it is designed to be driven with minimum human intervention. A redundant drive by wire (DBW) steering system is important for the ADV to ensure fail-safety performance, which requires a high level of redundancy with not only redundant hardware but also a robust redundant control system. To realize fully autonomous driving on the road, it is important for the steering control system to quickly adjust the control output after the primary steering system failure. Therefore, the efficient and intelligent control for the redundant DBW steering system is critical.

The conventional redundant steering control systems have several problems. In the conventional redundant steering control systems, the second steering system (SSS) may only be started after detecting the failure of the primary steering system (PSS), or run at the same time with the PSS, but just be allowed to engage the torque output after detecting the failure of the PSS. However, it may take a long time for the SSS to arrive at the desired position, which may be dangerous for the ADV due to unexpected instability. In addition, the angle of the PSS and SSS may be different even, if the installation position is the same, because of the sensor gap between the PSS and the SSS due to the sensor learning, gear gap, calculation speed, etc. The output values of the SSS may not be accurate to be used directly.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating an example of a redundant DBW steering system in an ADV according to one embodiment.

FIG. 5 is a block diagram illustrating controlling the redundant DBW steering system of FIG. 4 according to one embodiment.

FIG. 6 is a block diagram illustrating an example of the redundant DBW steering system control in an ADV according to one embodiment.

FIG. 7A is a block diagram illustrating an example of high-level steering control information of the redundant DBW steering system in an ADV according to one embodiment.

FIG. 7B is a block diagram illustrating an example of low-level steering motor control information of the redundant DBW steering system in an ADV according to one embodiment.

FIGS. 8A-8B are diagrams illustrating an example of the performance of the redundant DBW steering system in an ADV according to one embodiment.

FIG. 9 is a flow diagram illustrating an example of a process of controlling the redundant DBW steering system in an ADV according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, described herein are methods and systems for controlling a redundant DBW steering system in an ADV. The ADV includes a the redundant DBW steering system including a primary steering system (PSS) and a secondary steering system (SSS). The control information (e.g., control items) of the PSS may be transferred continuously to the SSS. The SSS may start to use the control information of the PSS after detecting the failure of the PSS. The SSS may also learn from the PSS the results of the steering control parameters. For example, the high-level control of the SSS may inherit the “profitable results” (e.g., control items) of the high-level control of the PSS. The motor control of the SSS may inherit the “profitable results” of the motor control of the PSS. The “profitable results” of the high-level control and/or motor control of the PSSS may be transferred to the SSS by a communication interface (CI), controller area network (CAN) 1, and/or CAN 2. The SSS may inherit the “profitable results” of the PSS and reset the SSS control items immediately while steering the ADV by using the closed-loop controller of the SSS. In this way, the redundant steering switching (from the PSS to the SSS) will be smooth (e.g., without vibration) and highly efficient.

According to some embodiments, steering control information and steering motor control information of a primary steering system of the ADV is determined. The steering control information and the steering motor control information of the primary steering system is transferred to a secondary steering system of the ADV. The ADV is controlled, by the primary steering system, to drive autonomously based on the steering control information and the steering motor control information of the primary steering system. In response to detecting a failure of the primary steering system, the ADV is controlled, by the secondary steering system, to drive autonomously based on the steering control information and the steering motor control information of the primary steering system.

In one embodiment, the steering control information may comprise at least one of a feedforward control term, a proportional control term, an integral control term, or a derivative control term.

In one embodiment, the steering motor control information may comprise at least one of a feedforward motor control term, a proportional motor control term, or an integral motor control term.

In one embodiment, the steering control information and the steering motor control information may be transferred from the primary steering system to the secondary steering system of the ADV by at least one of a computer interface (CI), a cable area network (CAN) interface 1, or a CAN interface 2.

In one embodiment, the ADV may be controlled by the SSS to drive autonomously based on a plurality of control terms of the steering control information and the steering motor control information of the primary steering system with a plurality of control gains, where each control term is associated with a control gain. In one embodiment, the plurality of control gains may be determined by tuning. In one embodiment, the plurality of control gains may be determined by setting up a lookup table based on at least one of a speed of the ADV, a predetermined steering angle, a target steering angle, or a road condition. In one embodiment, the plurality of control gains may be determined based on a target torque of a steering actuator of the secondary steering system. In one embodiment, the plurality of control gains may be determined by machine learning based on artificial intelligence.

In one embodiment, the steering control information and the steering motor control information of the primary steering system may be transferred to the secondary steering system in every planning cycle continuously.

In one embodiment, in response to detecting a failure of the primary steering system, the steering control information and steering motor control information of the secondary steering system may be reset based on the steering control information and the steering motor control information of the primary steering system.

In one embodiment, in response to detecting the failure of the primary steering system, the ADV may be controlled by the secondary steering system to drive autonomously based on both the steering control information and the steering motor control information of the primary steering system and the steering control information and the steering motor control information of the secondary steering system.

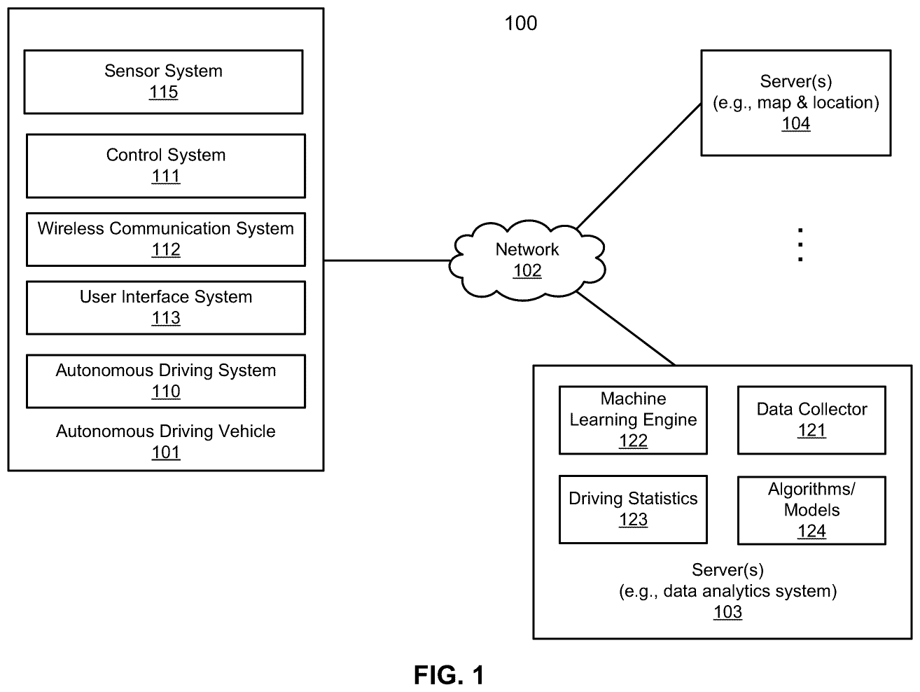

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

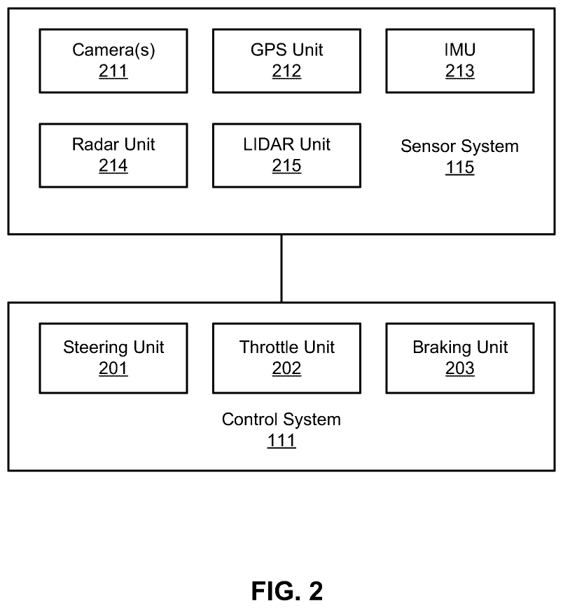

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. The details of the steering unit 201 will be discussed below. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. In one embodiment, algorithms 124 may include an algorithm or model to determine, by a primary steering system of the ADV, steering control information and steering motor control information of the primary steering system, an algorithm to control, by the primary steering system, the ADV to drive autonomously based on the steering control information and the steering motor control information, an algorithm to transfer, from the primary steering system to a secondary steering system of the ADV, the steering control information and the steering motor control information, and/or an algorithm to, in response to detecting a failure of the primary steering system, control, by the secondary steering system, the ADV to drive autonomously based on the steering control information and the steering motor control information transferred from the primary steering system. Algorithms 124 can then be uploaded on ADVs to be utilized during autonomous driving in real-time.

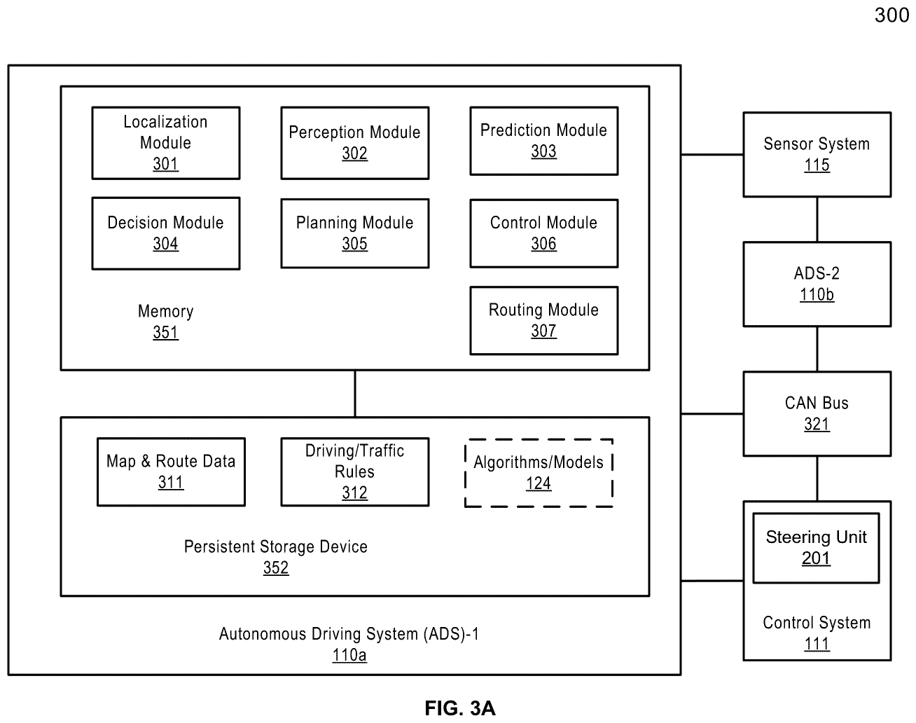

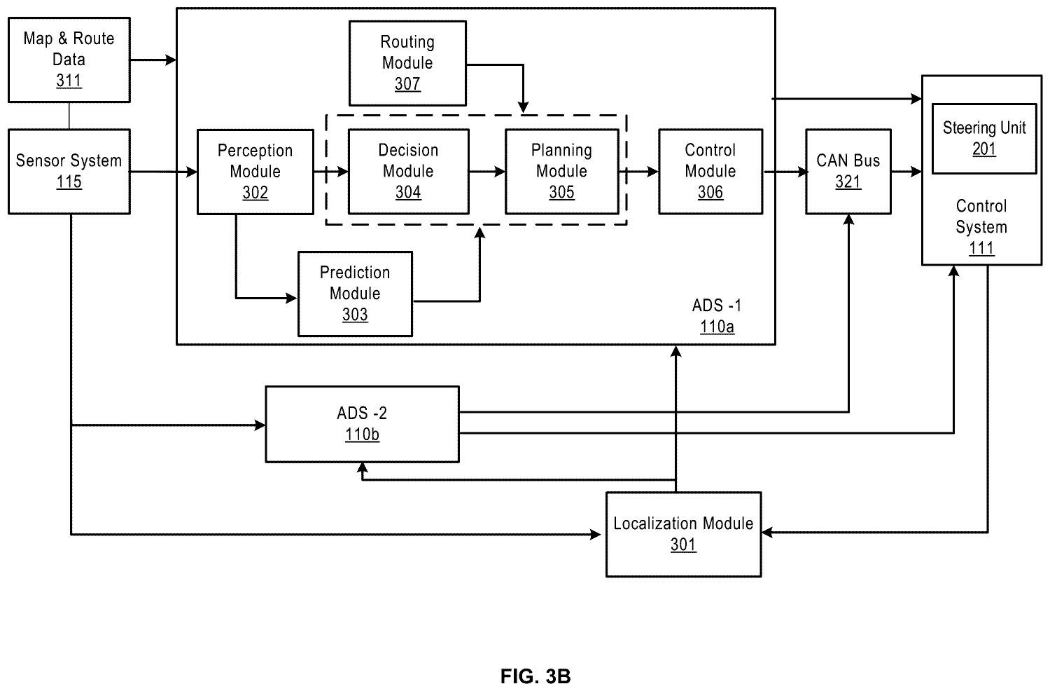

FIGS. 3A and 3B are block diagrams illustrating an example of an autonomous driving system (ADS) used with an ADV according to one embodiment. System 300 may be implemented as a part of ADV 101 of FIG. 1 including, but is not limited to, ADS-1 110a, ADS-2 110b, control system 111, sensor system 115 and CAN bus 321. The ADS-2 110b is a redundant system of ADS-1 110a. Referring to FIGS. 3A-3B, ADS-1 110a includes, but is not limited to, localization module 301, perception module 302, prediction module 303, decision module 304, planning module 305, control module 306, and routing module 307. ADS-2 110b includes redundant or similar modules as ADS-1 110a.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/rout information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 300 would move in a next moving cycle (e.g., next route/path segment). For example, the planning and control data may instruct vehicle 300 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

As illustrated in FIGS. 3A-3B, the ADS-2 110b can be provided as a backup or secondary ADS. When the ADS-1 110a or another software/hardware component in the ADV 101 fails to function properly, the ADS-2 110b may take over the control of the vehicle and transition the ADV 101 to a safer condition. Each module in FIGS. 3A and 3B can be implemented in software or hardware or a combination therefore.

In one embodiment, the ADS-2 110b can be a backup to the ADV-1 110a. While the ADS-1 110a is configured to drive the ADV in normal operations, the ADS-2 110b operates in a standby mode and is configured to monitor output parameters of each module in the ADS-1 110a. The ADS-2 110b can also monitor output parameters of the sensor system 115, the control system 111, the CAN bus component 321, and the ADS-2 110b itself. The output parameters of each software or hardware component to be monitored can be broadcast via the network to the ADS-2 110b. The ADS-2 110b can also directly communicate with the CAN bus component 321 without going through the network. The ADS-2 110b can compare the output parameters with expected output parameters to determine whether a malfunction has occurred. In the event of a malfunction, the ADS-2 110b can take appropriate actions based on a number of factors, including the frequency of the occurrence of the same malfunction, and its severity level. The actions of ADS-2 110b in response to detecting the failure of the primary steering system will be discussed below.

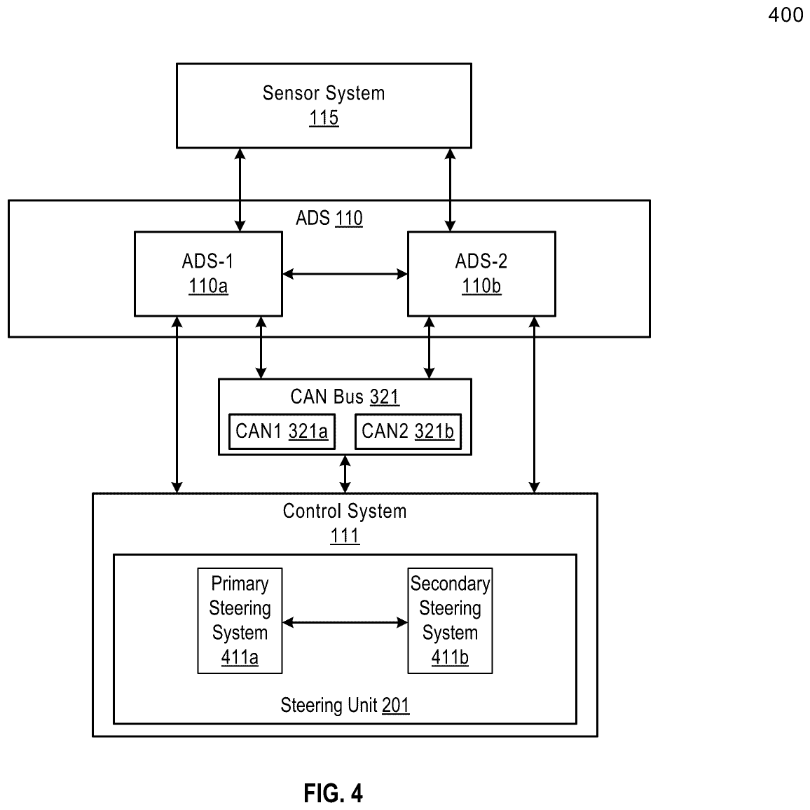

FIG. 4 is a block diagram illustrating an example of a redundant DBW steering system 400 in the ADV 101 according to one embodiment. The redundant DBW steering system 400 may include a primary steering system 411a and a secondary steering system 411b in the steering unit 201. Some or all of the redundant DBW steering system 400 may be implemented in hardware, software or a combination thereof. Note that some or all of the redundant DBW steering system 400 may be communicatively coupled to or integrated with some or all of other units of vehicle control system 111 in FIG. 2. The redundant DBW steering system 400 may use the DBW technology which uses electrical or electro-mechanical systems for performing vehicle functions traditionally achieved by mechanical linkages. The DBW technology replaces the traditional mechanical control systems with electronic control systems using electromechanical actuators and human-machine interfaces such as pedal and steering feel emulators.

Referring to FIG. 4, the ADV 101 may include the ADS-1 110a and the ADS-2 110b (which is the redundant system of ADS-1 110a). As discussed above, the control module of the ADS-1 110a controls and drives the ADV 101, by sending proper commands or signals to vehicle control system 111. The ADS-1 110a sends steering commands to the primary steering system 411a at different points in time along the path or route. The ADS-1 110a may send the steering commands by the CAN bus 321 or directly to the primary steering system 411a. In one embodiment, the CAN bus 321 may include a primary CAN bus CAN 1 321a and a secondary CAN bus CAN 2 321b. When the ADV 101 is operating normally, the ADS-1 110a controls the primary steering system 411a, the ADS-2 110b controls the secondary steering system 411b.

In some situations, the primary steering system 411a may fail. In some situations, the ADS-1 110a may fail. In some situations, both the primary steering system 411a and the ADS-1 110a may fail. When the failure of the primary steering system 411a and/or the ADS-1 110a happens, the secondary steering system 411b and/or the ADS-2 110b may be used to drive and control the ADV 101.

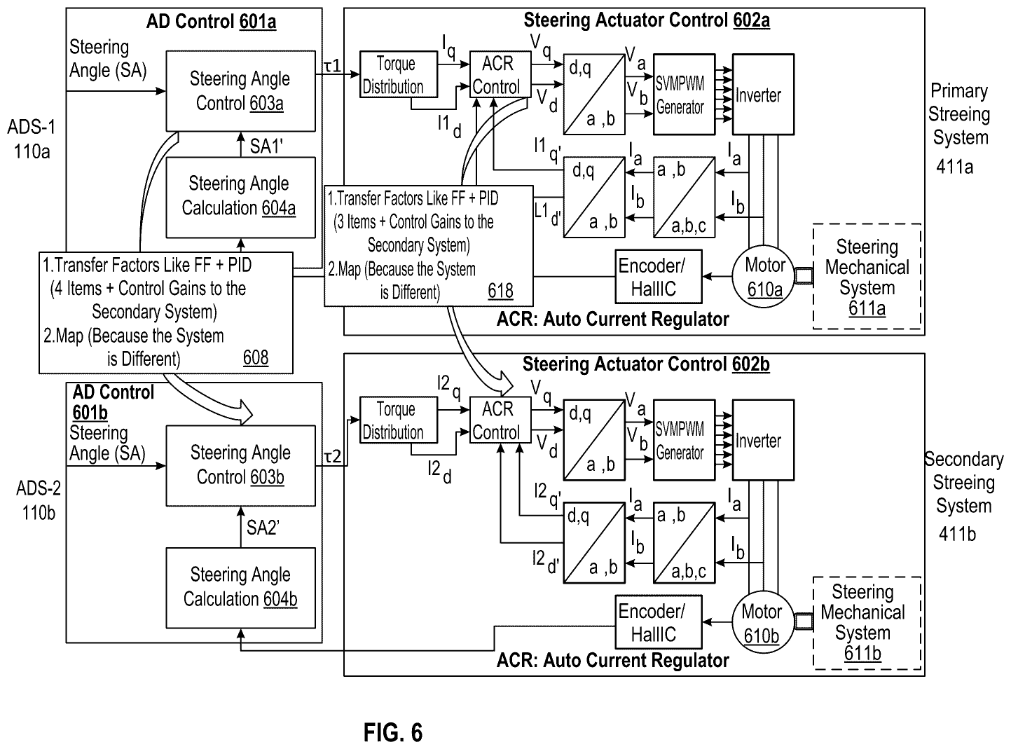

In some embodiments, if the primary steering system 411a fails but the ADS-1 110a is working, the ADS-1 110a is used to control the secondary steering system 411b. The primary system ADS-1 110a is the priority selection of the two ADS systems. The steering motor control information of the primary steering system 411a with respective control gains may be transferred to the secondary steering system 411b, which will be discussed in detail in connection with FIG. 6.

In some embodiments, if the primary steering system 411a works but the ADS-1 110a fails, the ADS-2 110b is used to control the primary steering system 411a. The primary steering system 411a is the priority selection of the two steering systems. The steering control information of the primary steering system 411 may be transferred to the ADS-2 110b. Because the ADS-2 110b is used to control the primary steering system 411a, there is no need to transfer the respective control gains of the steering control information in this situation.

In some embodiments, both the primary steering system 411a and the ADS-1 110a fail, the ADS-2 110b is used to control the secondary steering system 411b. For example, the ADS-2 110b may send the steering commands by the CAN 1 321a or CAN 2 321b or directly to the secondary steering system 411b to control and drive the ADV 101.

The redundant DBW steering system 400 provides a high level of redundancy with not only redundant hardware but also a robust redundant control system. The redundant DBW steering system 400 may quickly adjust the control output after the failure of the primary steering system 411a and/or ADS-1 110a, thereby improving the safety and efficiency of the ADV101.

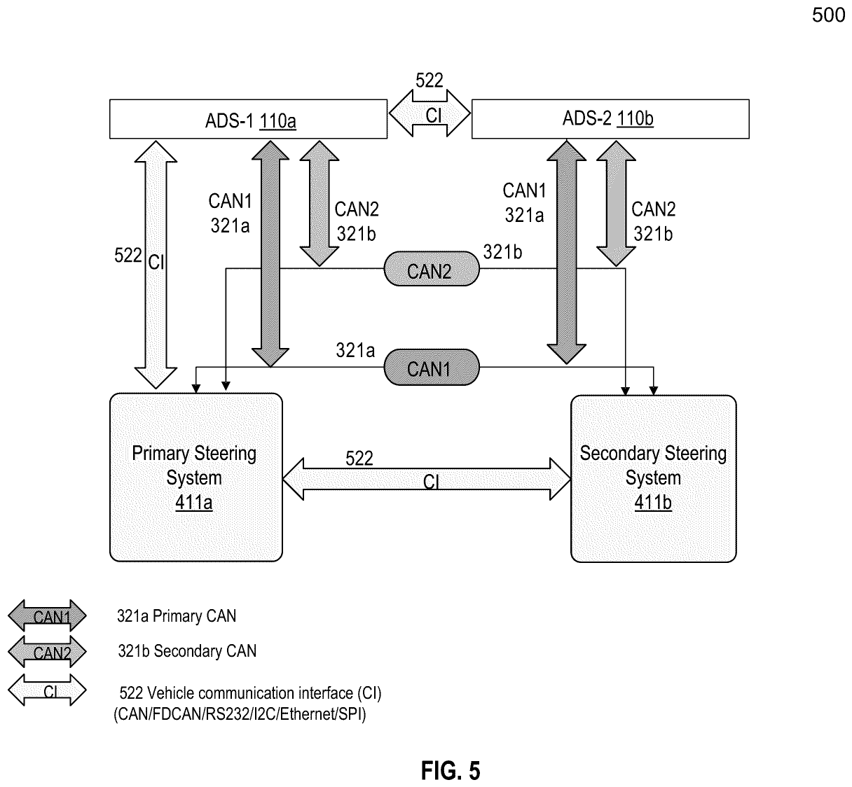

FIG. 5 is a block diagram illustrating controlling the redundant DBW steering system 400 of FIG. 4 according to one embodiment. The ADV 101 includes the redundant DBW steering system including the primary steering system (PSS) 411a and the secondary steering system (SSS) 411b. The PSS 411a steers the ADV 101 based on the steering commands from the ADS-1 110a along the path or route. In one embodiment, the ADS-1 110a may determine the control information of the PSS 411a. The control information of the PSS 411a may include one or more control items, which will be discussed below. The control information of the PSS 411a may include high-level control information and low-level motor control information of the PSS. The ADS-1 110a may generate steering commands for the PSS 411a based on the control information of the PSS. The ADS-1 110a may control the PSS 411a based on the control information of the PSS.

In one embodiment, the control information of the PSS 411a may be transferred to the SSS 411b/ADS-2 110b, e.g., in every planning cycle continuously, along the path or route. After detecting the failure of the PSS, the SSS 411b may immediately start to use the control information of the PSS. The SSS 411b may also learn from the PSS the results of the steering control parameters such as resistance, damping or temperature change. For example, the high-level control information of the SSS 411b may inherit the “profitable results” (e.g., control items) of the high-level control information of the PSS 411a. The motor control information of the SSS 411b may inherit the “profitable results” of the motor control information of the PSS 411a.

The “profitable results” (e.g., control items) of the high-level control and/or motor control of the PSS 411a may be transferred by a communication interface (CI) 522, CAN 1, and/or CAN 2. The CI 522 may include CAN, FDCAN, RS232, I2C, Ethernet, or SPI, or any other communication interface.

The SSS 411b may inherit the “profitable results” from the PSS 411a and reset the control information, e.g., control items, of the SSS immediately while steering the ADV 101 by using the closed-loop controller of the SSS. In this way, the redundant DBW steering system may provide smooth switching from the PSS 411a to the SSS 411b without vibration. Therefore, the redundant DBW steering system will improve the safety and efficiency of the ADV. For example, the redundant DBW steering system may save the switching time by 100, 200, 500, 1000 ms or any values therebetween.

FIG. 6 is a block diagram illustrating an example of the redundant DBW steering system control in the ADV according to one embodiment. Referring to FIG. 6, the controlling of the redundant DBW steering system may include high-level autonomous driving control 601a and low-level motor control 602a of the PSS 411a, high-level autonomous driving control 601b and low-level motor control 602b of the SSS 411b, and switching from the PSS 411a to the SSS 411b. The control information of the PSS 411a may include steering control information (e.g., high-level control information) and low-level motor control information of the PSS.

As illustrated in FIG. 6, for the PSS 411a, at the high-level autonomous driving control 601a, a steering angle of PSS 411a may be calculated at block 604a. The ADS-1 110a may determine/calculate the steering control information and the low-level motor control information of the PSS 411a along the path/route. The steering angle of PSS 411a may be determined based on the steering control information of the PSS 411a. The steering control information of the PSS 411a may refer to the high-level steering control information of the PSS 411a. The PSS 411a may have a closed-loop proportional-integral-derivative controller (PID) controller. The high-level steering control information of the PSS 411a may include multiple control terms, such as a feedforward control term, a proportional control term, an integral control term, and/or a derivative control term. At block 603a, ADS-1 110a may perform steering angle control of the PSS 411a by outputting the torque value τ1 according to the steering angle determined based the high-level steering control information of the PSS 411a.

At the low-level motor control 602a, based on the torque value τ1, a primary motor 610a may be controlled by a steering actuator including an auto current regulator (ACR). The primary motor 610a may be coupled to a steering mechanical system 611a to control the steering mechanical system 611a. The ACR control may be based on steering motor control information of the PSS. The steering motor control information of the PSS 411a may include several control terms, such as a feedforward motor control term, a proportional motor control term, and/or an integral motor control term.

As illustrated in block 608, the ADS-1 110a may continuously transfer the steering control information of the PSS 411a to the ADS-2 110b while controlling the ADV 101 using the PSS 411a. The steering control information of the PSS 411a may be high-level control information and include multiple control terms, such as a feedforward control term, a proportional control term, an integral control term, and/or a derivative control term. Each of the multiple control terms may have a respective control gain. In one embodiment, multiple controls gains associated with the multiple control terms may be transferred from the ADS-1 110a to the ADS-2 110b. In one embodiment, the multiple controls gains associated with the multiple control terms may be determined by the ADS-2 110b. The PSS 411a and the SSS 411b are not identical, and there are some differences between the PSS 411a and the SSS 411b due to sensor calibration, mechanical margin tolerance, etc. In one embodiment, the multiple controls gains associated with the multiple control terms may be determined by tuning. In one embodiment, the multiple controls gains associated with the multiple control terms may be determined by using a lookup table or a map table based on a speed of the ADV, a predetermined steering angle, a target steering angle, or a road condition. In one embodiment, the control terms of the SSS may be obtained by using a fixed ratio to transfer the control terms of the PSS to the SSS.

As illustrated in block 618, the PSS 411a may continuously transfer the steering motor control information of the PSS 411a to the SSS 411b while controlling the ADV 101. The steering motor control information of the PSS 411a may be low-level control information. The steering motor control information of the PSS 411a include multiple control terms, such as a feedforward motor control term, a proportional motor control term, and/or an integral motor control term. Each of the multiple motor control terms may have a respective control gain. In one embodiment, multiple controls gains associated with the multiple motor control terms may be transferred from the PSS 411a to the SSS 411b. In one embodiment, the multiple controls gains associated with the multiple motor control terms may be determined by the ADS-2 110b. Because the PSS 411a and the SSS 411b are different, a lookup table based on a speed of the ADV, a predetermined steering angle, a target steering angle, or a road condition may be used to as a map to determine multiple controls gains associated with the multiple motor control terms.

The ADV 101 may be controlled by the PSS 411a to drive autonomously based on the steering control information and the steering motor control information of the PSS. When the failure of the PSS 411a happens, the SSS 411b may immediately control the ADV 101 based on the steering control information and the low-level motor control information of the PSS 411a. Since the steering control information and the low-level motor control information of the PSS 411a have been continuously transferred to the SSS 411b, the SSS 411b may use the steering control information and the low-level motor control information of the PSS 411a immediately after the failure of the PSS 411a.

In one embodiment, the SSS 411b may reset the steering control information and low-level motor control information of the SSS 411b based on the steering control information and the low-level motor control information of the PSS 411a immediately after the failure of the PSS. After resetting, the SSS 411b may start to control the ADV. Thus, the switching from the PSS 411a to the SSS 411b will be smooth without vibration and highly efficient.

As an example, when the ADV 101 is controlled by the PSS 411a, the control terms of the steering control information and the steering motor control information of the PSS 411a may be computed/calculated and transferred to the SSS 411b continuously, while the control terms of the steering control information and the steering motor control information of the SSS 411b may not be computed/calculated. After detecting the failure of the PSS 411a, the SSS 411b may reset each control term of the steering control information and low-level motor control information of the SSS 411b as the corresponding control term of the steering control information and the low-level motor control information of the PSS 411a multiplied by a respective control gain. Then, the ADV may be controlled by the SSS 411b to drive autonomously based on the control terms of the steering control information and the steering motor control information of the PSS 411a.

As another example, when the ADV 101 is controlled by the PSS 411a, the control terms of the steering control information and the steering motor control information of the PSS 411a may be computed/calculated and transferred to the SSS 411b continuously, and the control terms of the steering control information and the steering motor control information of the SSS 411b may also be computed/calculated. After detecting the failure of the PSS 411a, the SSS 411b may compare each control term of the steering control information or low-level motor control information of the SSS 411b with the corresponding control term of the steering control information or the low-level motor control information of the PSS 411a. If the difference between a control term of the steering control information or the low-level motor control information of the SSS 411b and a corresponding control term of the steering control information or the low-level motor control information of the PSS 411a is less than a predetermined threshold, the SSS 411b may use the control term of the steering control information or the low-level motor control information of the SSS 411b. If the difference between the control term of the steering control information or the low-level motor control information of the SSS 411b and the corresponding control term of the steering control information or the low-level motor control information of the PSS 411a is not less than the predetermined threshold, the SSS 411b may reset the control term of the steering control information or the low-level motor control information of the SSS 411b by using a reasonable value between the control term of the steering control information or the low-level motor control information of the SSS 411b and the corresponding control term of the steering control information or the low-level motor control information of the PSS 411a, e.g., an average of the control term of the SSS 411b and the corresponding control term of the PSS 411a. The ADV may be controlled by the SSS 411b to drive autonomously based on both the steering control information and the steering motor control information of the PSS 411a and the steering control information and the steering motor control information of the SSS 411b.

Afterwards, at the high-level AD control 601b, the ADS-2 110b may determine the steering control information and the steering motor control information of the SSS 411b at block 604b. At block 603b, ADS-2 110b may perform steering angle control of the SSS 411b by outputting the torque value τ2 according to the steering angle determined based the high-level steering control information of the SSS 411b. At the low-level motor control 602b, based on the torque value τ2, a secondary motor 610b may be controlled by a steering actuator including an ACR to control a steering mechanical system 611b.

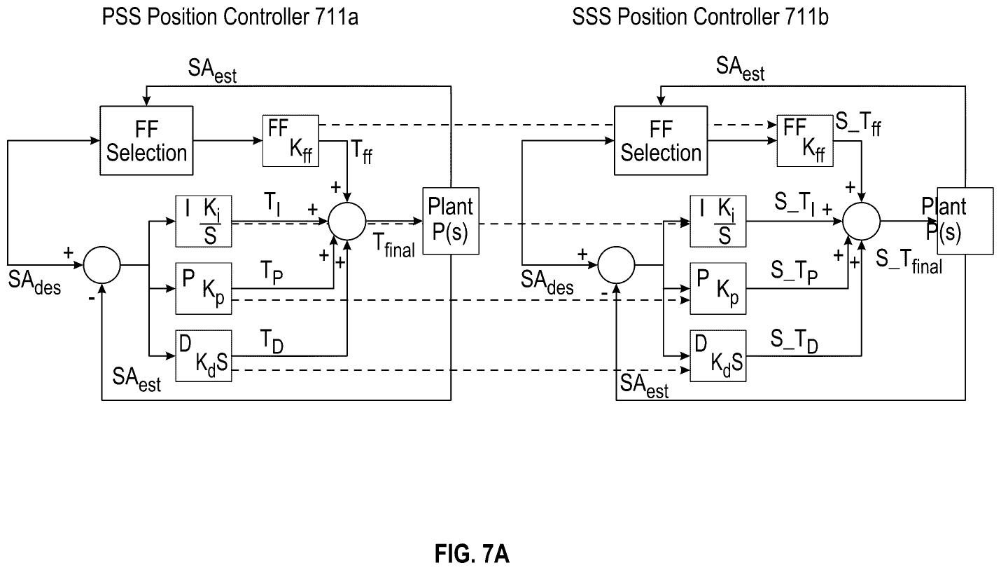

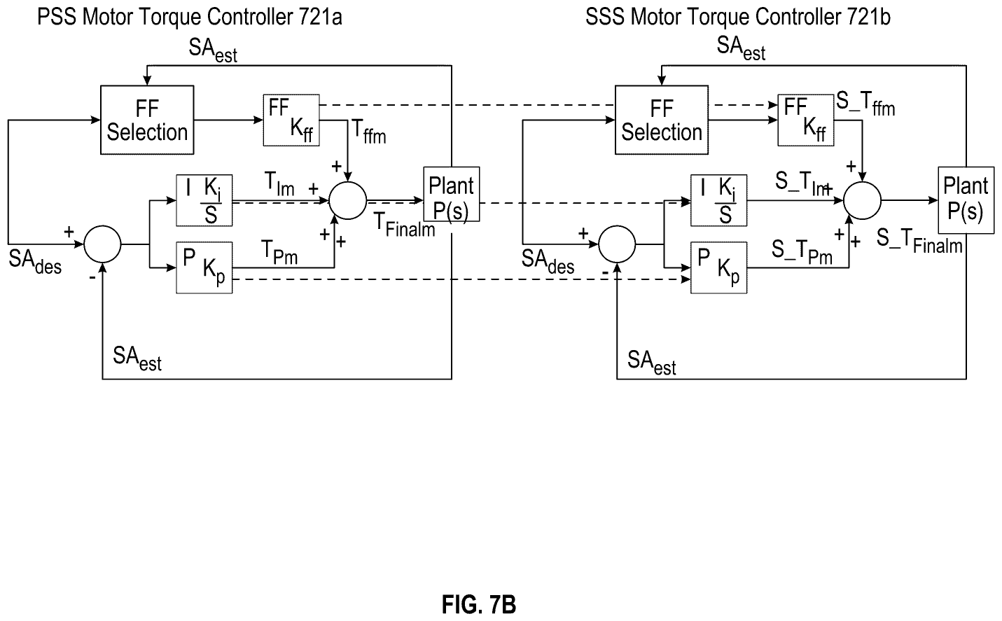

FIG. 7A is a block diagram illustrating an example of high-level steering control information of the redundant DBW steering system in the ADV 101 according to one embodiment. At the high-level autonomous driving control, the PSS 411a may include a PSS position controller 711a, e.g., a close-loop PID controller. The steering control information of the PSS 411a may refer to the high-level steering control information of the PSS position controller 711a. The high-level steering control information of the PSS 411a may include multiple control terms of the PSS position controller 711a. Referring to FIG. 7A, the control terms of the PSS position controller 711a may include a feedforward control term T_{ff}, a proportional control term T_{P}, an integral control term T_{I}, and/or a derivative control term T_{D}. The control terms of the PSS position controller 711a may be transferred to a SSS position controller 711b.

When detecting the failure of the PSS 411a, the SSS 411b may reset the control terms of the SSS position controller 711b of the SSS 411b based on the control terms of the PSS position controller 711a. The SSS 411b may include the SSS position controller 711b. The control terms of the SSS 411b may be control terms of the SSS position controller 711b. The control terms of the SSS position controller 711b may include a secondary feedforward control term S_T_{ff}, a secondary proportional control term S_T_{P}, a secondary integral control term S_T_{I}, and/or a secondary derivative control term S_T_{D}. The control terms of the SSS position controller 711b may be determined based on the control terms of the PSS position controller 711a. The multiple control terms of the SSS position controller 711b may be determined based on the multiple control terms of the PSS position controller 711a and multiple control gains. In one embodiment, each of the control terms of the SSS position controller 711b may be determined based on a respective control term of the PSS position controller 711a multiplied by a respective control gain. The multiple control terms of the SSS position controller 711b may be determined as below:

$${S\_T}_{ff} = R 1 * {T}_{ff} ,$$

$${S\_T}_{I} = R 2 * {T}_{I} ,$$

$${S\_T}_{P} = R 3 * {T}_{P} ,$$

$${S\_T}_{D} = R 4 * {T}_{D} ,$$

where R1, R2, R3, and R4 are control gains of the secondary feedforward control term S_T_{ff}, the secondary integral control term S_T_{I}, the secondary proportional control term S_T_{P}, and the secondary derivative control term S_T_{D}, respectively.

In one embodiment, the control gains R1, R2, R3, and R4 may be determined by tuning to find the best values. In one embodiment, the control gains R1, R2, R3, and R4 may be determined by setting up a lookup table based on at least one of a speed of the ADV, a predetermined steering angle, a target steering angle, or a road condition. In one embodiment, the control terms of the SSS position controller 711b may be obtained by using a fixed ratio to transfer the control terms of the PSS position controller 711a to the SSS position controller. For example, the transferred control terms (e.g., torque) may be obtained by:

$${S\_T}_{ff} = {R}_{f} * {T}_{ff} / {T}_{final} ,$$

$${S\_T}_{I} = {R}_{f} * {T}_{I} / {T}_{final} ,$$

$${S\_T}_{P} = {R}_{f} * {T}_{P} / {T}_{final} ,$$

$${S\_T}_{D} = {R}_{f} * {T}_{D} / {T}_{final} ,$$

where R_{f} is a fixed ratio, and T_{final} represents a final control term of the PSS position controller 711a. As illustrated in FIG. 7A, T_{final} may be determined based on the feedforward control term T_{ff}, the proportional control term T_{P}, the integral control term T_{I}, and/or the derivative control term T_{D}. Comparing to the embodiment discussed above, in this embodiment, only the fixed ratio R_{f} is to be determined instead of 4 different control gains R1-R4. Thus, the calibration process is faster and easier.

In one embodiment, the control gains R1, R2, R3, and R4 may be determined by machine learning based on artificial intelligence.

FIG. 7B is a block diagram illustrating an example of low-level steering motor control information of the redundant DBW steering system in the ADV 101 according to one embodiment. At the low-level autonomous driving control, the steering motor control information of the PSS 411a may include multiple steering motor control terms of a PSS motor torque controller 721a. Referring to FIG. 7B, the steering motor control terms of the PSS motor torque controller 721a may include a feedforward motor control term T_{ffm}, a proportional motor control term T_{Pm}, and/or an integral motor control term T_{Im}. The steering motor control terms of the PSS motor torque controller 721a may be transferred to a SSS motor torque controller 721b.

When detecting the failure of the PSS 411a, the SSS 411b may reset the steering motor control terms of the SSS motor torque controller 721b of the SSS 411b based on the steering motor control terms of the PSS motor torque controller 721a. The steering motor control terms of the SSS motor torque controller 721b may include a secondary motor feedforward control term S_T_{ffm}, a secondary motor proportional control term S_T_{Pm}, and/or a secondary motor integral control term S_T_{Im}. The steering motor control terms of the SSS motor torque controller 721b may be determined based on the steering motor control terms of the PSS motor torque controller 721a. The multiple steering motor control terms of the SSS motor torque controller 721b may be determined based on the multiple steering motor control terms of the PSS motor torque controller 721a and multiple control gains. In one embodiment, each of the steering motor control terms of the SSS motor torque controller 721b may be determined based on a respective steering motor control term of the PSS motor torque controller 721a multiplied by a respective control gain. The multiple steering motor control terms of the SSS motor torque controller 721b may be determined as below:

$${S\_T}_{ffm} = R 5 * {T}_{ffm} ,$$

$${S\_T}_{Im} = R 6 * {T}_{Im} ,$$

$${S\_T}_{Pm} = R 7 * {T}_{Pm} ,$$

where R5, R6, and R7 are control gains of the secondary feedforward motor control term S_T_{ffm}, the secondary integral motor control term S_T_{Im}, and the secondary proportional motor control term S_T_{Pm}, respectively.

In one embodiment, the control gains R5, R6, and R7 may be determined by tuning to find the best values. In one embodiment, the control gains R5, R6, and R7 may be determined by setting up a lookup table based on at least one of a speed of the ADV, a predetermined steering angle, a target steering angle, or a road condition. In one embodiment, the control terms of the SSS motor torque controller 721b may be obtained by using a fixed ratio to transfer the control terms of the PSS motor torque controller 721a to the SSS motor torque controller. For example, the transferred control terms (e.g., torque) may be obtained by:

$${S\_T}_{ffm} = {R}_{fm} * {T}_{ffm} / {T}_{finalm} ,$$

$${S\_T}_{Im} = {R}_{fm} * {T}_{Im} / {T}_{finalm} ,$$

$${S\_T}_{Pm} = {R}_{fm} * {T}_{Pm} / {T}_{finalm} ,$$

where R_{fm} is a fixed ratio, and T_{finalm} represents a final control term of the PSS motor torque controller 721a. As illustrated in FIG. 7B, T_{finalm} may be determined based on the feedforward motor control term T_{ffm}, the proportional motor control term T_{Pm}, and/or the integral motor control term T_{Im}. Comparing to the embodiment discussed above, in this embodiment, only the fixed ratio R_{fm} is to be determined instead of 3 different control gains R5-R7. Thus, the calibration process is faster and easier.

In one embodiment, the control gains R5, R6, and R7 may be determined by machine learning based on artificial intelligence.

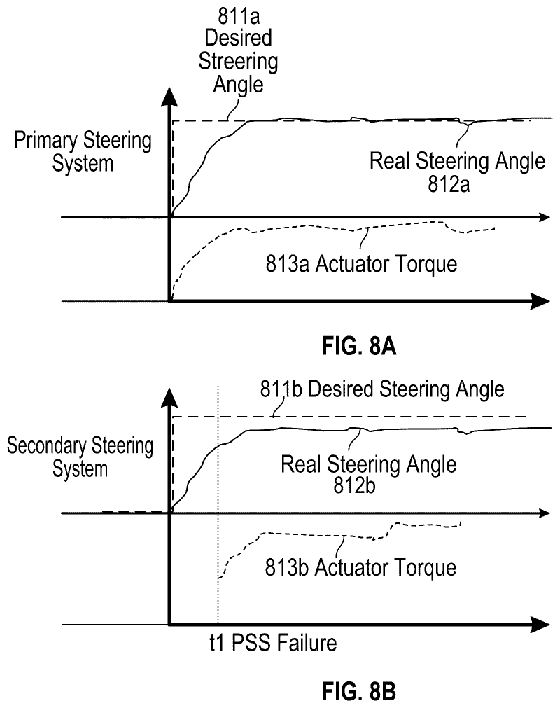

FIGS. 8A-8B are diagrams illustrating an example of the performance of the redundant DBW steering system in the ADV 101 according to one embodiment. Referring to FIG. 8A, when the primary steering system is operating normally (e.g., no failure), the PSS actuator torque 813a is controlled by the PSS controller (e.g., PSS motor torque controller 721a), the actual steering angle 812a may be controlled to be close to the desired steering angle 811a.

Referring to FIG. 8B, at time t1, the failure of the primary steering system may occur. When detecting the failure of the primary steering system, by using the redundant DBW steering system control discussed above, the secondary steering control and motor control of the secondary steering system can inherit the “profitable results” of the primary steering system. As illustrated in FIG. 8B, after the failure of the primary steering system, the SSS actuator torque 813b from the SSS controller (e.g., SSS motor torque controller 721b) is close to the PSS actuator torque 813a. The actual steering angle 812b is controlled to be close to the desired steering angle 811b. Thus, by using the redundant DBW steering system control, the handover procedure to the secondary steering system will be smooth and efficient, thereby improving the safety, comfort and efficiency of the ADV.

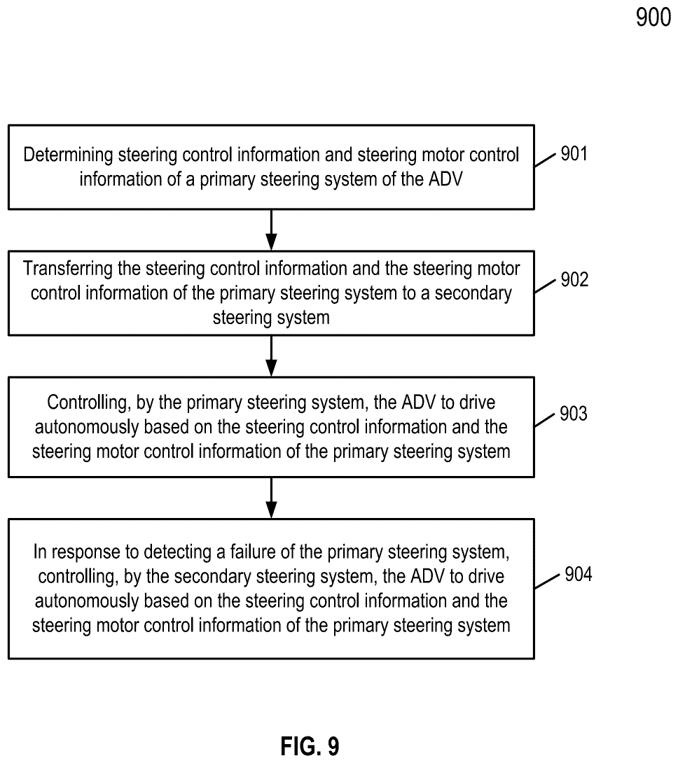

FIG. 9 is a flow diagram illustrating an example of a process of controlling the redundant DBW steering system in an ADV according to one embodiment. Process 900 may be performed by processing logic which may include software, hardware, or a combination thereof. For example, process 900 may be performed by the ADS-1 110a, ADS-2, 110b, PSS 411a, and/or SSS 411b, as illustrated in FIG. 4. Referring to FIG. 9, in operation 901, processing logic determines steering control information and steering motor control information of a primary steering system of the ADV. In operation 902, processing logic transfers the steering control information and the steering motor control information of the primary steering system to a secondary steering system. In operation 903, processing logic controls, by the primary steering system, the ADV to drive autonomously based on the steering control information and the steering motor control information of the primary steering system. In operation 804, in response to detecting a failure of the primary steering system, processing logic controls, by the secondary steering system, the ADV to drive autonomously based on the steering control information and the steering motor control information of the primary steering system.

By this process, the redundant DBW steering system may provide smooth switching from the PSS to the SSS, e.g., without vibration. Therefore, the redundant DBW steering system will improve the safety, comfort and efficiency of the ADV. For example, the redundant DBW steering system may save the switching time by 100, 200, 500, 1000 ms or any values therebetween.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method for operating an autonomous driving vehicle (ADV), comprising:
determining steering control information and steering motor control information of a primary steering system of the ADV;
transferring the steering control information and the steering motor control information of the primary steering system to a secondary steering system;
controlling, by the primary steering system, the ADV to drive autonomously based on the steering control information and the steering motor control information of the primary steering system; and
in response to detecting a failure of the primary steering system, controlling, by the secondary steering system, the ADV to drive autonomously based on the steering control information and the steering motor control information of the primary steering system.

2. The method of claim 1, wherein the steering control information comprises at least one of a feedforward control term, a proportional control term, an integral control term, or a derivative control term.

3. The method of claim 1, wherein the steering motor control information comprises at least one of a feedforward motor control term, a proportional motor control term, or an integral motor control term.

4. The method of claim 1, wherein the steering control information and the steering motor control information of the primary steering system are transferred to the secondary steering system by at least one of a computer interface (CI), a cable area network (CAN) interface 1, or a CAN interface 2.

5. The method of claim 1, where in the controlling, by the secondary steering system, the ADV to drive autonomously based on the steering control information and the steering motor control information of the primary steering system comprises:
controlling, by the secondary steering system, the ADV to drive autonomously based on a plurality of control terms of the steering control information and the steering motor control information of the primary steering system with a plurality of control gains, wherein each control term is associated with a control gain.

6. The method of claim 5, further comprising determining the plurality of control gains by tuning.

7. The method of claim 5, further comprising determining the plurality of control gains by setting up a lookup table based on at least
one of a speed of the ADV, a predetermined steering angle, a target steering angle, or a road condition.

8. The method of claim 5, further comprising determining the plurality of control gains based on a target torque of a steering actuator of the secondary steering system.

9. The method of claim 5, further comprising determining the plurality of control gains by machine learning based on artificial intelligence.

10. The method of claim 1, wherein the steering control information and the steering motor control information of the primary steering system are transferred to the secondary steering system in every planning cycle continuously.

11. The method of claim 1, further comprising in response to detecting the failure of the primary steering system, resetting the steering control information and steering motor control information of the secondary steering system based on the steering control information and the steering motor control information of the primary steering system.

12. The method of claim 1, further comprising determining steering control information and steering motor control information of the secondary steering system, wherein the in response to detecting a failure of the primary steering system, controlling, by the secondary steering system, the ADV to drive autonomously based on the steering control information and the steering motor control information of the primary steering system comprises:
in response to detecting a failure of the primary steering system, controlling, by the secondary steering system, the ADV to drive autonomously based on both the steering control information and the steering motor control information of the primary steering system and the steering control information and the steering motor control information of the secondary steering system.

13. A non-transitory machine-readable medium having instructions stored therein, which when executed by a processor, cause the processor to perform operations, the operations comprising:
determining steering control information and steering motor control information of a primary steering system of the ADV;
transferring the steering control information and the steering motor control information of the primary steering system to a secondary steering system;
controlling, by the primary steering system, the ADV to drive autonomously based on the steering control information and the steering motor control information of the primary steering system; and
in response to detecting a failure of the primary steering system, controlling, by the secondary steering system, the ADV to drive autonomously based on the steering control information and the steering motor control information of the primary steering system.

14. The non-transitory machine-readable medium of claim 13, wherein the steering control information comprises at least one of a feedforward control term, a proportional control term, an integral control term, or a derivative control term, and wherein the steering motor control information comprises at least one of a feedforward motor control term, a proportional motor control term, or an integral motor control term.

15. The non-transitory machine-readable medium of claim 13, wherein the steering control information and the steering motor control information of the primary steering system are transferred to the secondary steering system by at least one of a computer interface (CI), a cable area network (CAN) interface 1, or a CAN interface 2.

16. The non-transitory machine-readable medium of claim 13, wherein the controlling, by the secondary steering system, the ADV to drive autonomously based on the steering control information and the steering motor control information of the primary steering system comprises:
controlling, by the secondary steering system, the ADV to drive autonomously based on a plurality of control terms of the steering control information and the steering motor control information of the primary steering system with a plurality of control gains, wherein each control term is associated with a control gain.

17. A data processing system, comprising:
a processor; and
a memory coupled to the processor to store instructions, which when executed by the processor, cause the processor to perform operations, the operations including:
determining steering control information and steering motor control information of a primary steering system of the ADV;
transferring the steering control information and the steering motor control information of the primary steering system to a secondary steering system;
controlling, by the primary steering system, the ADV to drive autonomously based on the steering control information and the steering motor control information of the primary steering system; and
in response to detecting a failure of the primary steering system, controlling, by the secondary steering system, the ADV to drive autonomously based on the steering control information and the steering motor control information of the primary steering system.

18. The data processing system of claim 17, wherein the steering control information comprises at least one of a feedforward control term, a proportional control term, an integral control term, or a derivative control term, and wherein the steering motor control information comprises at least one of a feedforward motor control term, a proportional motor control term, or an integral motor control term.

19. The data processing system of claim 17, wherein the steering control information and the steering motor control information of the primary steering system are transferred to the secondary steering system by at least one of a computer interface (CI), a cable area network (CAN) interface 1, or a CAN interface 2.

20. The data processing system of claim 17, wherein the controlling, by the secondary steering system, the ADV to drive autonomously based on the steering control information and the steering motor control information of the primary steering system comprises:
controlling, by the secondary steering system, the ADV to drive autonomously based on a plurality of control terms of the steering control information and the steering motor control information of the primary steering system with a plurality of control gains, wherein each control term is associated with a control gain.
